(19) United States
(12) Patent Application Publication
(10) Pub. No.: US 2016/0187457 A1
(43) Pub. Date: Jun. 30, 2016

(54) HYBRID MODEL FOR SMART POSITIONING DATA PROCESSING

(71) Applicant: QUALCOMM Incorporated, San Diego, CA (US)

(72) Inventors: Jiajian CHEN, San Jose, CA (US); Saumitra Mohan DAS, Santa Clara, CA (US); Faraz MOHAMMAD MIRZAEI, San Jose, CA (US)

(21) Appl. No.: 14/584,212

(22) Filed: Dec. 29, 2014

(51) Int. Cl. G01S 5/02; G01S 5/14

(52) U.S. Cl. CPC G01S 5/0252; G01S 5/14

(57) ABSTRACT

Methods and apparatus for processing positioning data are provided. In an example, a method for processing positioning data associated with one or more access points includes choosing, for inclusion in the positioning data, one or both of: (1) ranging model parameters to enable a mobile device to compute first heatmap data for multiple points in a ranging region of a heatmap, or (2) second heatmap data for a plurality of points in a non-ranging region of the heatmap. The method can also include transmitting the positioning data, such as to a mobile device. The positioning data can also include both the ranging model parameters and the second heatmap data when the ranging region and the non-ranging region fully or partially overlap, in which case the second heatmap data provides correction data to enable the mobile device to modify the computed heatmap data in the area where the two regions overlap.

### FIELD OF DISCLOSURE

This disclosure relates generally to electronics, and more specifically, but not exclusively, to methods and apparatus for communicating positioning data.

### BACKGROUND

Determining a wireless access point's (AP) signal coverage is an important factor in determining a position of a mobile device, particularly in indoor environments where satellite-based positioning techniques are unavailable or unreliable. A mobile device conventionally uses a positioning engine to determine the mobile device's position. One input to the positioning engine is received signal strength indication (RSSI) measurements of signals transmitted from APs. Additionally, a positioning server receives AP transmission data for the APs and provides, to the mobile device, heatmap information that is based on the transmission data, such as an RSSI heatmap or a round-trip-time (RTT) heatmap.

An RSSI heatmap is a map of the wireless signal strength for a particular AP based on a distance from the AP's antenna. Heatmaps are very accurate. Unfortunately, heatmaps are represented by a large amount of data, and transmitting heatmap data requires significant transmission time and power consumption.

A position fix for the mobile device is conventionally determined using AP transmission power data, the measured RSSI values, and the RSSI heatmap. The position fix is determined by the mobile device or the positioning assistance server. The RSSI measurement results are evaluated against the RSSI heatmap to infer the mobile device's position. The conventional technique's determine the mobile device's position without the mobile device associating or authenticating with the APs. However, the conventional positioning system requires frequent data exchange between the mobile device and the positioning server. The positioning data (a.k.a. assistance data) can contain identification data of hundreds of APs and each AP's respective heatmap data.

An alternative to using a heatmap is using a ranging model that estimates the respective AP's RSSI at specific points distant from the access point's antenna. A ranging model includes equations and parameters that can be used by the mobile device to estimate the wireless AP's signal coverage. The ranging model parameters have a very small data size and are practically suitable for transmission from an access point to a mobile device. However, using a ranging model is not a perfect solution for all conditions, as the ranging model results are not sufficiently accurate for all realistic conditions.

Conventional methods and devices implement only one of these techniques (i.e., use either a heatmap or a ranging model), and thus suffer from the problems associated with the implemented technique. Accordingly, there are long-felt industry needs for methods and apparatus that improve upon conventional methods and apparatus, including the improved methods and apparatus provided hereby.

### SUMMARY

This summary provides a basic understanding of some aspects of the present teachings. This summary is not exhaustive in detail, and is neither intended to identify all critical features, nor intended to limit the scope of the claims. Exemplary methods and apparatus for processing positioning data are provided.

In example, provided is a method for processing positioning data associated with one or more access points. The method includes choosing, for inclusion in the positioning data, one or both of: (1) ranging model parameters to enable a mobile device to compute first heatmap data for multiple points in a ranging region of a heatmap, and (2) second heatmap data for a plurality of points in a non-ranging region of the heatmap. The method also includes transmitting the positioning data.

In example, provided is a server for processing positioning data associated with one or more access points. The server includes a processor and a memory coupled to the processor. The memory is configured to cause the processor to choose, for inclusion in the positioning data, one or both of: (1) ranging model parameters to enable a mobile device to compute first heatmap data for multiple points in a ranging region of a heatmap, and (2) second heatmap data for a plurality of points in a non-ranging region of the heatmap. The memory is also configured to cause the processor to transmit the positioning data.

In example, provided is a non-transitory computer-readable medium, including processor-executable instructions stored thereon to be retrieved and executed by one or more processors, the processor-executable instructions including instructions to choose, for inclusion in positioning data, one or both of: (1) ranging model parameters to enable a mobile device to compute first heatmap data for multiple points in a ranging region of a heatmap, and (2) second heatmap data for a plurality of points in a non-ranging region of the heatmap. The processor-executable instructions also include instructions to transmit the positioning data.

In example, provided is a server configured to process positioning data associated with one or more access points. The server includes means for choosing, for inclusion in the positioning data, one or both of: (1) ranging model parameters to enable a mobile device to compute first heatmap data for multiple points in a ranging region of a heatmap, and (2) second heatmap data for a plurality of points in a non-ranging region of the heatmap. The server also includes means for transmitting the positioning data.

In example, provided is a mobile device configured to process positioning data associated with one or more access points. The mobile device includes a processor and a memory coupled to the processor. The memory stores instructions configured to cause the processor to: (1) receive ranging model parameters from an access point; and (2) compute heatmap data for each of multiple points in a ranging region of a heatmap, based on the received ranging model parameters.

In a further example, provided is a method for processing positioning data associated with one or more access points. The method includes: (1) receiving ranging model parameters from an access point; and (2) computing heatmap data for each of multiple points in a ranging region of a heatmap, based on the received ranging model parameters.

In example, provided is a non-transitory computer-readable medium including processor-executable instructions stored thereon to be retrieved and executed by one or more processors, the processor-executable instructions including instructions to: (1) receiving ranging model parameters from an access point; and (2) compute heatmap data for each of multiple points in a ranging region of a heatmap, based on the received ranging model parameters.

In example, provided is a mobile device configured to process positioning data associated with one or more access points. The mobile device includes: (1) means for receiving ranging model parameters from an access point; and (2) means for computing heatmap data for each of multiple points in a ranging region of a heatmap, based on the received ranging model parameters.

In example, provided is a positioning server configured to process positioning data associated with an access point having an antenna. The positioning server includes a processor and a memory coupled to the processor. The memory stores instructions configured to cause the processor to: (1) compute heatmap data representing signal parameters for the access point at a plurality of points distant from the access point's antenna; and (2) analyze the computed heatmap data, and, if a ranging region is found in the heatmap data, compute ranging model parameters of a signal strength of a transmission from the access point's antenna.

In a further example, provided is a method for processing positioning data associated with an access point having an antenna. The method includes: (1) computing heatmap data representing signal parameters for the access point at a plurality of points distant from the access point's antenna; and (2) analyzing the computed heatmap data, and, if a ranging region is found in the heatmap data, compute ranging model parameters of a signal strength of a transmission from the access point's antenna.

In example, provided is a non-transitory computer-readable medium including processor-executable instructions stored thereon to be retrieved and executed by one or more processors, the processor-executable instructions including instructions to: (1) compute heatmap data representing signal parameters for the access point at a plurality of points distant from the access point's antenna; and (2) analyze the computed heatmap data, and, if a ranging region is found in the heatmap data, compute ranging model parameters of a signal strength of a transmission from the access point's antenna.

In example, provided is a positioning server configured to process positioning data associated with one or more access points. The positioning server includes: (1) means for computing heatmap data representing signal parameters for the access point at a plurality of points distant from the access point's antenna; and (2) means for analyzing the computed heatmap data, and, if a ranging region is found in the heatmap data, compute ranging model parameters of a signal strength of a transmission from the access point's antenna.

The foregoing broadly outlines some of the features and technical advantages of the present teachings in order that the detailed description and drawings can be better understood. Additional features and advantages are also described in the detailed description. The conception and disclosed embodiments can be readily utilized as a basis for modifying or designing other structures for carrying out the same purposes of the present teachings. Such equivalent constructions do not depart from the technology of the teachings as set forth in the claims. The inventive features that are characteristic of the teachings, together with further objects and advantages, are better understood from the detailed description and the accompanying figures. Each of the figures is provided for the purpose of illustration and description only, and does not limit the present teachings.

### BRIEF DESCRIPTION OF THE DRAWINGS

The accompanying drawings are presented to describe examples of the present teachings, and are not limiting.

FIG. 1 depicts an exemplary wireless communication network.

FIG. 2 depicts a functional block diagram of an exemplary user device.

FIG. 3 depicts functional block diagrams of an exemplary access point and an exemplary positioning server.

FIG. 4 depicts an exemplary heatmap of a wireless access point's signal strength.

FIG. 5 depicts an exemplary irregular heatmap.

FIG. 6 depicts an example of how a ranging model can be used to approximate a regular heatmap.

FIG. 7 depicts an exemplary irregular heatmap that has partially-circular characteristics and a clearly irregular portion.

FIG. 8 depicts an exemplary method for selecting positioning data to transmit from an access point to a mobile device.

FIG. 9 depicts an exemplary method for processing positioning data associated with one or more access points.

FIG. 10 depicts another exemplary method processing positioning data associated with one or more access points.

FIG. 11 depicts an exemplary method for processing positioning data associated with an access point having an antenna.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

### Introduction

Improved methods and apparatus for communicating positioning data are provided. To take advantage of benefits of both heatmaps and ranging models, provided is a hybrid model for transmitting access point data between a mobile device and a positioning server. The exemplary apparatuses and methods disclosed herein advantageously address the long-felt industry needs, as well as other previously unidentified needs, and mitigate shortcomings of the conventional methods and apparatus. For example, an advantage provided by the disclosed apparatuses and methods herein is a reduction in processing time over conventional devices, because the mobile device can access the access point's signal coverage data faster. Other advantages over conventional methods and apparatus include a reduction in the time required to transmit positioning data, as well as a reduction in power consumption required to transmit positioning data, because less positioning data is transmitted from the access point to the mobile device. Further advantages include a reduction in network bandwidth consumption brought about by reducing an amount of data required to be transmitted—a smaller quantity of ranging parameter data is transmitted instead of a relatively large quantity of received signal strength indication (RSSI) and/or round-trip time (RTT) data for a large number of points in a grid.

Exemplary embodiments are disclosed in this application's text and drawings. Alternate embodiments can be devised without departing from the scope of the invention. Additionally, conventional elements of the current teachings may not be described in detail, or may be omitted, to avoid obscuring aspects of the current teachings.

As used herein, the term “exemplary” means “serving as an example, instance, or illustration.” Any embodiment described as “exemplary” is not necessarily to be construed as preferred or advantageous over other embodiments. Likewise, the term “embodiments of the invention” does not require that all embodiments of the invention include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

It should be noted that the terms “connected,” “coupled,” and any variant thereof, mean any connection or coupling between elements, either direct or indirect, and can encompass a presence of an intermediate element between two elements that are “connected” or “coupled” together via the intermediate element. Coupling and connection between the elements can be physical, logical, or a combination thereof. Elements can be “connected” or “coupled” together, for example, by using one or more wires, cables, printed electrical connections, electromagnetic energy, and the like. The electromagnetic energy can have a wavelength at a radio frequency, a microwave frequency, a visible optical frequency, an invisible optical frequency, and the like. These are several non-limiting and non-exhaustive examples.

The term “signal” can include any signal such as a data signal, an audio signal, a video signal, a multimedia signal, an analog signal, a digital signal, and the like. Information can be represented using any of a variety of different technologies and techniques. For example, data, an instruction, a process step, a command, information, a signal, a bit, a symbol, and the like can be represented by a voltage, a current, an electromagnetic wave, a magnetic field, a magnetic particle, an optical field, and optical particle, and any combination thereof.

A reference using a designation such as “first,” “second,” and so forth does not limit either the quantity or the order of those elements. Rather, these designations are used as a convenient method of distinguishing between two or more elements. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” used in the description or the claims can be interpreted as “A or B or C or any combination of these elements.”

The terminology used herein is for the purpose of describing particular embodiments only and is not intended to be limiting. As used herein, the singular forms “a,” “an,” and “the” include the plural forms as well, unless the context clearly indicates otherwise. Further, the terms “comprises,” “comprising,” “includes,” and “including,” specify a presence of a feature, an integer, a step, a block, an operation, an element, a component, and the like, but do not necessarily preclude a presence or an addition of another feature, integer, step, block, operation, element, component, and the like.

The provided apparatuses can be a part of, and/or coupled to, an electronic device such as, but not limited to, at least one of a mobile device, a navigation device (e.g., a global positioning system receiver), a wireless device a camera, an audio player, a camcorder, and a game console.

The term “mobile device” can describe, and is not limited to, at least one of a mobile phone, a mobile communication device, a pager, a personal digital assistant, a personal information manager, a personal data assistant (PDA), a mobile hand-held computer, a portable computer, a tablet computer, a wireless device, a wireless modem, other types of portable electronic devices typically carried by a person and having communication capabilities (e.g., wireless, cellular, infrared, short-range radio, etc.), a tablet computer, and any other device that is capable of receiving wireless communication signals used in determining a position fix. Further, the terms “user equipment” (UE), “mobile terminal,” “user device,” “mobile device,” and “wireless device” can be interchangeable.

### DESCRIPTION OF THE FIGURES

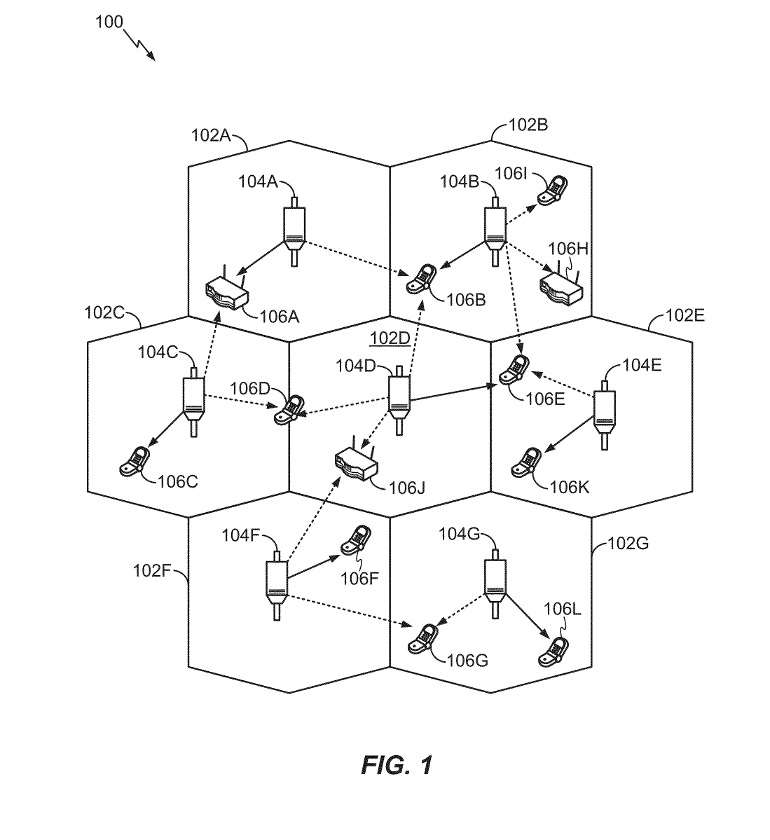

FIG. 1 depicts an exemplary wireless communication network 100. The wireless communication network 100 is configured to support multiple access communication between multiple users. As shown, the wireless communication network 100 can be divided into one or more cells 102A-102G. One or more access points 104A-104G provides communication coverage in corresponding cells 102A-102G. The access points 104A-104G can interact with at least one user device in a plurality of user devices 106A-106L.

Each user device 106A-106L can communicate with one or more of the access points 104A-104G via a downlink (DL) and/or an uplink (UL). In general, a DL is a communication link from an access point to a user device, while an UL is a communication link from a user device to an access point. The access points 104A-104G can be coupled to each other and/or other network equipment via wired or wireless interfaces, allowing the access points 104A-104G to communicate with each other and/or the other network equipment. Accordingly, each user device 106A-106L can also communicate with another user device 106A-106L via one or more of the access points 104A-104G. For example, the user device 106J can communicate with the user device 106H in the following manner: the user device 106J can communicate with the access point 104D, the access point 104D can communicate with the access point 104B, and the access point 104B can communicate with the user device 106H, allowing communication to be established between the user device 106J and the user device 106H.

A wireless communication network, such as the wireless communication network 100, can provide service over a geographic region ranging from small to large. For example, the cells 102A-102G can cover a few blocks within a neighborhood or several square miles in a rural environment. In some systems, each of the cells 102A-102G can be further divided into one or more sectors (not shown in FIG. 1). In addition, the access points 104A-104G can provide the user devices 106A-106L within their respective coverage areas (i.e., respective cells 102A-102G) with access to other communication networks, such as at least one of the Internet, a cellular network, a private network, and the like. In the example shown in FIG. 1, the user devices 106A, 106H, and 106J comprise routers, while the user devices 106B-106G, 106I, 106K, and 106L comprise mobile phones. However, each of the user devices 106A-106L can comprise any suitable communication device.

At least a portion of the apparatus disclosed herein can be a part of at least one of the access points 104A-104G and/or by at least one of the user devices 106A-106L. Also, at least a portion of the methods disclosed herein can be performed by at least one of the access points 104A-104G and/or by at least one of the user devices 106A-106L. Further, embodiments of the disclosure can be practicably employed in a device configured to process data relating to mobile device positioning.

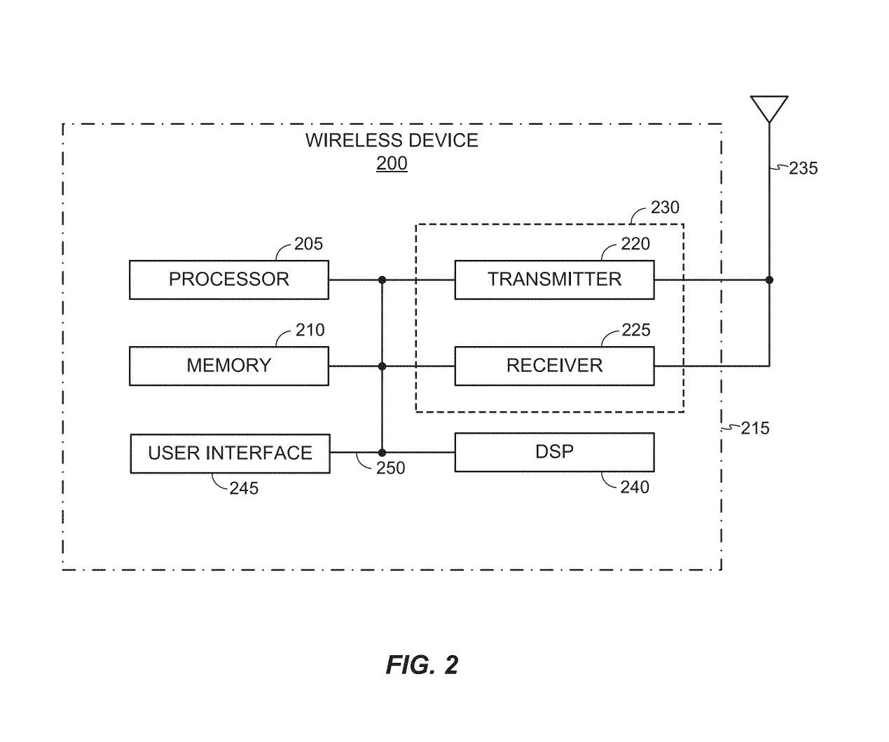

FIG. 2 depicts an exemplary functional block diagram of an exemplary user device 200, which can correspond to at least one of the user devices 106A-106L. FIG. 2 also depicts different components that can a part of the user device 200. The user device 200 is an example of a device that can be configured to include at least a portion of the apparatus described herein.

The user device 200 can include a processor 205 which is configured to control operation of the user device 200, including performing at least a part of a method described herein. The processor 205 can also be referred to as a central processing unit (CPU) and as a special-purpose processor. A memory 210, which can include at least one of read-only memory (ROM) or random access memory (RAM) provides at least one of instructions and data to the processor 205. The processor 205 can perform logical and arithmetic operations based on processor-executable instructions stored within the memory 210. The instructions stored in the memory 210 can be executed to implement at least a part of a method described herein.

The processor 205 can comprise or be a component of a processing system implemented with one or more processors. The one or more processors can be implemented with at least one of a microprocessor, a microcontroller, a digital signal processor (DSP), a field programmable gate array (FPGA), a programmable logic device (PLD), an application-specific integrated circuit (ASIC), a controller, a state machine, gated logic, a discrete hardware component, a dedicated hardware finite state machine, and any other suitable entity that can at least one of manipulate information (e.g., calculating, logical operations, and the like) and control another device. The processing system can also include a non-transitory machine-readable media (e.g., the memory 210) that stores software. Software can mean any type of instructions, whether referred to as at least one of software, firmware, middleware, microcode, hardware description language, and the like. Instructions can include code (e.g., in source code format, binary code format, executable code format, or any other suitable code format). The instructions, when executed by the processor 205, can transform the processor 205 into a special-purpose processor that causes the processor to perform at least a part of a function described herein.

The user device 200 can also include a housing 215, a transmitter 220, and a receiver 225 to allow transmission and reception of data between the user device 200 and a remote location. The transmitter 220 and the receiver 225 can be combined into a transceiver 230. An antenna 235 can be attached to the housing 215 and electrically coupled to the transceiver 230. The user device 200 can also include (not shown in FIG. 2) multiple transmitters, multiple receivers, multiple transceivers, and/or multiple antennas.

The user device 200 can further comprise a digital signal processor (DSP) 240 that is configured to process data. The user device 200 can also further comprise a user interface 245. The user interface 245 can comprise at least one of a keypad, a microphone, a speaker, and a display. The user interface 245 can include a component that at least one of conveys information to a user of the user device 200 and receives input from the user.

The components of the user device 200 can be coupled together by a bus system 250. The bus system 250 can include at least one of a data bus, a power bus, a control signal bus, and a status signal bus. The components of the user device 200 can be coupled together to accept or provide inputs to each other using a different suitable mechanism.

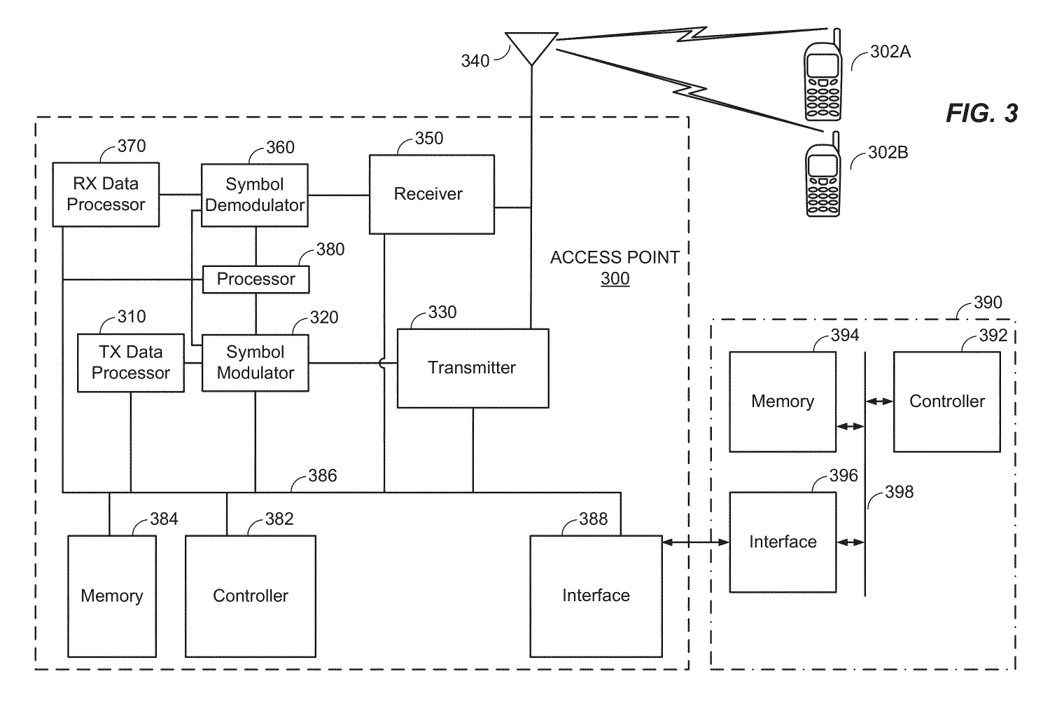

FIG. 3 depicts an exemplary access point 300 and a positioning server 390. The access point 300 can correspond to any of the access points 104A-104G. As shown, the access point 300 includes a transmit (TX) data processor 310, a symbol modulator 320, a transmitter unit (TMTR) 330, an antenna 340, a receiver unit (RCVR) 350, a symbol demodulator 360, a receive (RX) data processor 370, and a configuration information processor 380, each performing an operation associated with communicating with one or more user devices 302A-302B. The user devices 302A-302B can correspond to at least one user device in a plurality of user devices 106A-106L. The access point 300 can also include a controller 382 and a memory 384 configured to store related data or instructions. Together, via a bus system 386, these units can perform special-purpose processing in accordance with the appropriate radio communication technology, as well as other functions for the access point 300.

The controller 382 is configured to control operation of the access point 300. The controller 382 can also be referred to as a central processing unit (CPU) and as a special-purpose processor. The memory 384, which can include at least one of read-only memory (ROM) or random access memory (RAM) provides instructions and data to the controller 382. The controller 382 can perform logical and arithmetic operations based on program instructions stored within the memory 384. The instructions in the memory 384 can be executable to implement at least a part of a method described herein.

The controller 382 can comprise or be a component of a processing system implemented with one or more processors. The one or more processors can be implemented with at least one of a microprocessor, a microcontroller, a digital signal processor (DSP), a field programmable gate array (FPGA), a programmable logic device (PLD), an application-specific integrated circuit (ASIC), a controller, a state machine, gated logic, a discrete hardware component, a dedicated hardware finite state machine, and any other suitable entity that can at least one of manipulate information (e.g., calculating, logical operations, and the like) and control another device. The processing system can also include a non-transitory machine-readable media (e.g., the memory 384) that stores software. Software can mean any type of instructions, whether referred to as at least one of software, firmware, middleware, microcode, hardware description language, and the like. Instructions can include code (e.g., in source code format, binary code format, executable code format, or any other suitable code format). The instructions, when executed by the processor, can transform the processor into a special-purpose processor that causes the processor to perform at least a part of a function described herein.

The components of the access point 300 can be coupled together by the bus system 386. The bus system 386 can include at least one of a data bus, a power bus, a control signal bus, and a status signal bus. The components of the access point 300 can be coupled together to accept and/or provide inputs to each other using a different suitable mechanism.

The access point 300 can include an interface 388 that is configured to couple at least one of the constituent components of the access point 300 to the positioning server 390.

FIG. 3 also depicts the positioning server 390. In an example, the positioning server 390 includes a controller 392, a memory 394, an interface 396, and a bus system 398.

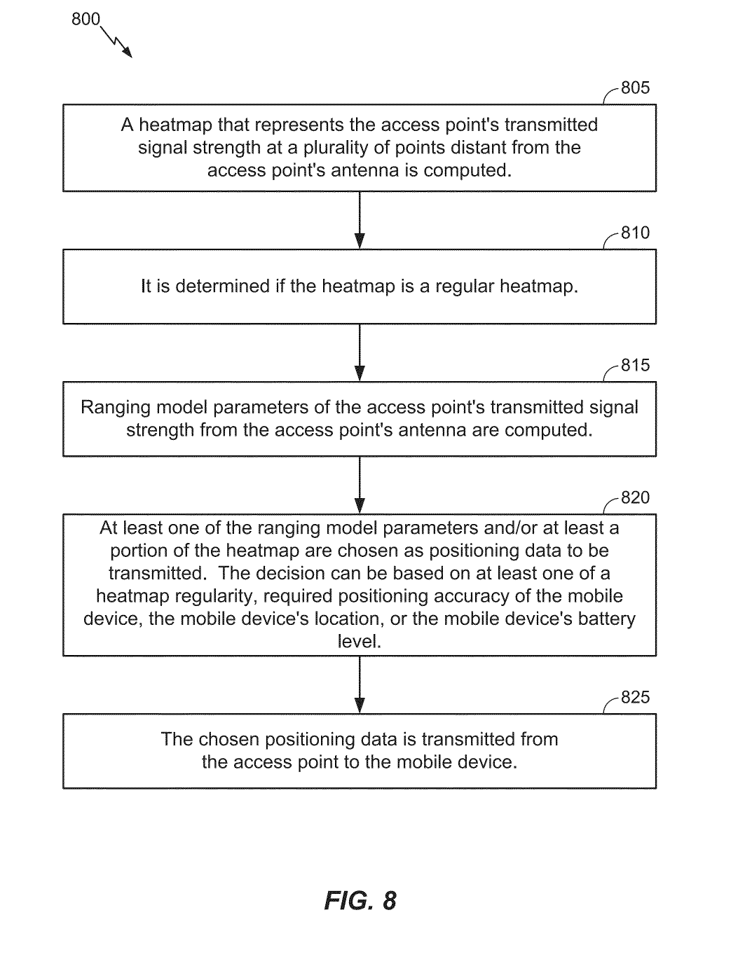

The controller 392 is configured to control operation of the positioning server 390. The controller 392 can be a central processing unit (CPU) and/or a special-purpose processor. The memory 394, which can include at least one of read-only memory (ROM) and/or random access memory (RAM) provides at least one of instructions and data to the controller 392. The controller 392 can perform logical and arithmetic operations based on processor-executable instructions stored within the memory 394. The instructions in the memory 394 can be executable to implement at least a part of a method described herein, for example, at least a part of the methods of FIGS. 8, 9, 10, and/or 11. The interface 396 is configured to couple at least one of the constituent components of the positioning server 390 to the access point 300.

The controller 392 can comprise or be a component of a processing system implemented with one or more processors. The one or more processors can be implemented with at least one of a microprocessor, a microcontroller, a digital signal processor (DSP), a field programmable gate array (FPGA), a programmable logic device (PLD), an application-specific integrated circuit (ASIC), a controller, a state machine, gated logic, a discrete hardware component, a dedicated hardware finite state machine, and any other suitable entity that can at least one of manipulate information (e.g., calculating, logical operations, and the like) and control another device. The processing system can also include a non-transitory machine-readable media (e.g., the memory 394) that stores software. Software can mean any type of instructions, whether referred to as at least one of software, firmware, middleware, microcode, hardware description language, and the like. Instructions can include code (e.g., in source code format, binary code format, executable code format, or any other suitable code format). The instructions, when executed by the controller 392, can transform the controller 392 into a special-purpose processor that causes the processor to perform at least a part of a function described herein.

The components of the positioning server 390 can be coupled together by the bus system 398. The bus system 398 can include at least one of a data bus, a power bus, a control signal bus, and a status signal bus. The components of the positioning server 390 can be coupled together to accept and/or provide inputs to each other using a different suitable mechanism.

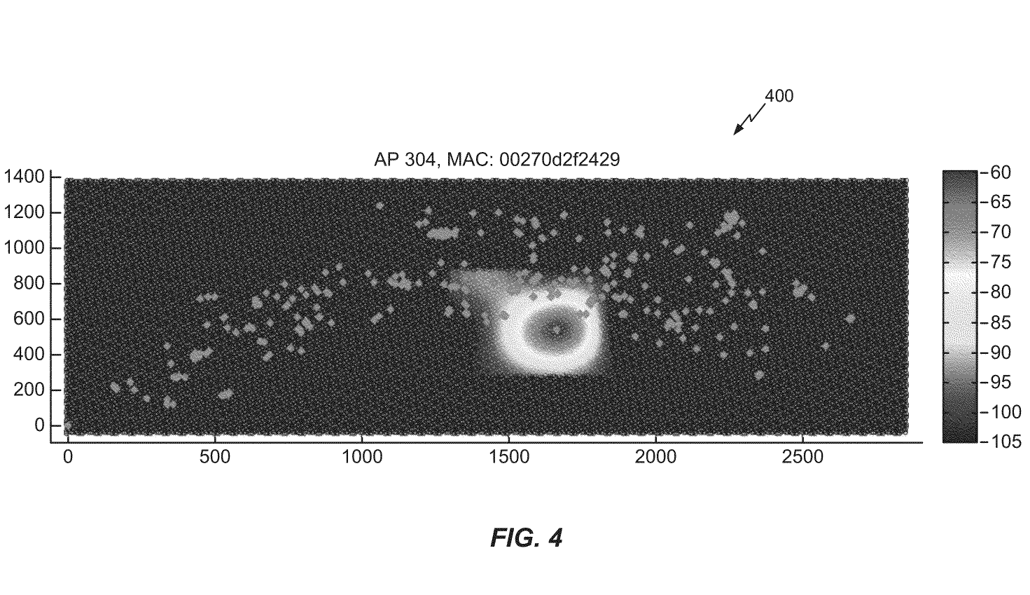

FIG. 4 depicts an exemplary heatmap 400 of a wireless access point's signal strength (for example, an access point similar to the access point 300 of FIG. 3) at specific points distant from the access point's antenna (also known as a Received Signal Strength Indication (RSSI) heatmap). The heatmap 400 includes uniformly-spaced grid points laid over geographic locations (e.g., a map) at a uniform separation. For example, in FIG. 4, the X-axis and the Y-axis indicate a distance from an origin point. The origin need not be centered at the antenna of the access point, but can be centered at any suitable point, including at the antenna of the access point. The distance can be measured using any suitable units (e.g., feet, meters, and the like).

The RSSI data for the access point is associated with respective grid points of the heatmap 400. The graph on the right of FIG. 4 depicts an exemplary RSSI scale ranging from −60 dBm to −105 dBm, as well as a spectrum associated with the RSSI values on the scale. A measured RSSI value can be used to determine a point on the scale spectrum, which in turn is used to identify at least one location on the heatmap. Also, a value from the heatmap can be compared to the scale spectrum to determine an RSSI value at a specific location represented by the heatmap. Thus, the mobile device can match measured RSSI of an acquired signal from an access point with RSSI data from the heatmap to determine, such as through inference, the location of the mobile device relative to the access point.

The heatmap can also include metadata such as the MAC ID address of the respective access point. For example, the heatmap 400 includes metadata identifying that access point number 304 has MAC ID 00270d2f2429, and that the heatmap 400 is for the access point number 304. The heat map also depicts that the access point number 304 is located at approximately 1700 on the X-axis and approximately 550 on the Y-axis. Also, as depicted in FIG. 4, locations of other access points relative to each other can be indicated by a heatmap. Thus, by determining multiple ranges to the antennas of multiple access points, the mobile device can accurately obtain a position fix. For example, the diamond shapes in the heatmap 400 indicate locations of other access points.

The heatmap 400 is an example of a “regular” heatmap. In an example, a regular heatmap represents a substantially equal RSSI at grid points that are substantially equidistant from the associated access point's antenna. In another example, a regular heatmap represents an RSSI having a symmetrical distribution along an axis (e.g., an oval-shaped distribution, an elliptical-shaped distribution, and the like). Although the heatmap 400 is largely regular, or can reasonably be represented with a ranging model such as a closed-form mathematical expression, the heatmap 400 does have some irregularity. For example, as illustrated, the heatmap 400 has some irregularity in shape in the upper left hand quadrant from the access point 304. However, such an irregularity may be relatively small, and ignoring such an irregularity may introduce relatively little error in a position fix calculation. Hence, only the regular portion of the heatmap 400 is used.

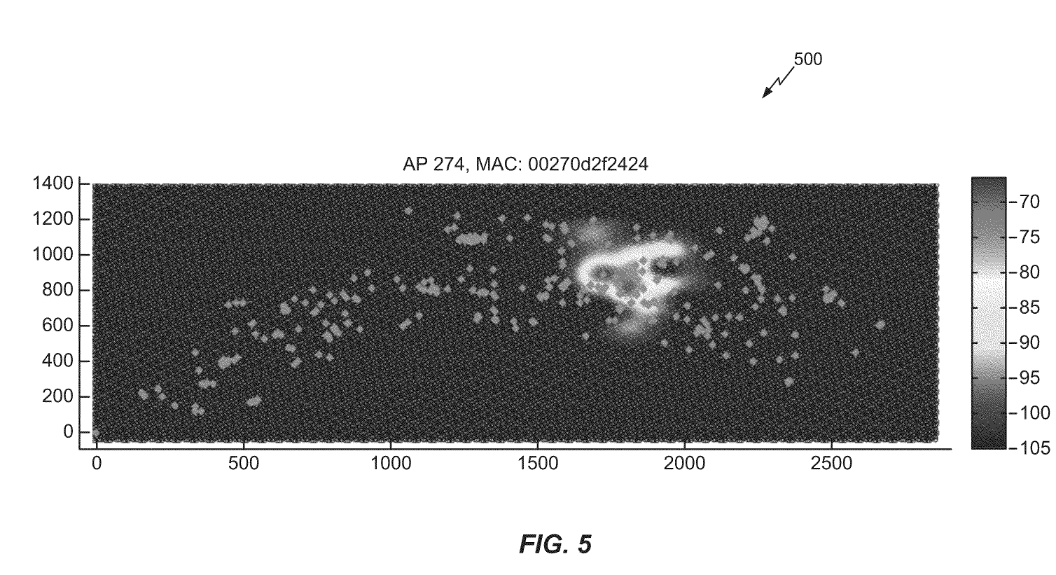

In contrast, FIG. 5 depicts an exemplary “irregular” heatmap 500 for access point number 274. In an example, an irregular heatmap represents a substantially unequal RSSI at grid points that are substantially equidistant from the associated access point's antenna. In another example, an irregular heatmap represents an RSSI having an asymmetrical distribution (e.g., a splatter-shaped distribution, a substantially unevenly-shaped distribution, and the like).

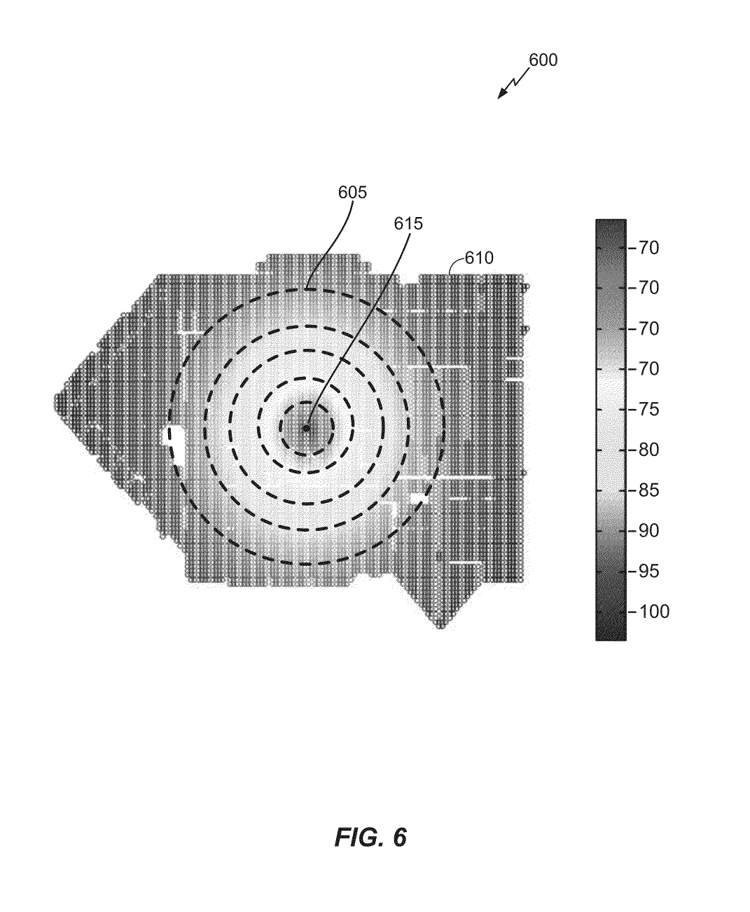

FIG. 6 depicts how a ranging model 600 can be used to approximate a regular heatmap. FIG. 6 depicts exemplary contour lines 605 superimposed on an exemplary regular heatmap 610. The contour lines 605 are generated by a ranging model equation and approximate the regular heatmap 610. The contour lines 605 substantially represent an access point's RSSI at grid points that are substantially equidistant from a location of the access point's antenna 615.

A measured RSSI value can be used to determine a point on the contour lines 605, which in turn is used to identify a location of the mobile device relative to the location of the access point's antenna 615. Thus, the mobile device can match the measured RSSI of the acquired signal from the access point with the contour lines 605 from the ranging model 600 to determine a distance from the location of the access point's antenna 615 (which does not specify a specific grid point, but a plurality of possible grid points). The location of the mobile device can be determined by combining data such as a contour line on which the mobile device is likely to be (relative to the access point's antenna) with other data, such as a heatmap of one or more other access points, which may or may not be represented by a respective ranging model.

An exemplary ranging model equation, used when implementing the ranging model 600, is as follows:

m(X)=TxPower−L−0.5s log₁₀(|X−c∥²)

where “TxPower” is the transmitted power from the access point's transmitter,
“L” is an antenna loss factor,
“s” is a dissipation scale,
“X” is a location where an RSSI measurement is taken (e.g., a heatmap cell), and
“c” is the location of the access point.

In an example, the “c” and the “TxPower” factors can be transmitted to a mobile device, and nominal values can be used for “X,” “s,” and “L.” Alternatively, parameters “X,” “s,” and “L” can also be transmitted to the mobile device.

Thus, when a ranging model is used, less data is sent to the mobile device than when heatmap data is sent to the mobile device. More generally, a regular heatmap, or a heatmap having a ranging region, refers to a heatmap or a region of a heatmap where the heatmap data, such as, for example RSSI and/or RTT parameters, can reasonably be represented with a ranging model such as a closed-form mathematical expression such as the exemplary ranging model equation provided above. Such a regular heatmap may be circular, that is a heatmap having substantially equal RSSI values at grid points that are substantially equidistant from the associated access point's antenna as provided in the example of FIGS. 4 and 6, but the heatmap need not be circular. Other regular profiles for the heatmap are possible, such as elliptical, or other shapes. In general, a regular heatmap will be a heatmap having a large amount of RSSI, RTT, or other transmission parameter data that can be modeled and/or computed by a mobile device using relatively few parameters compared to the transmission parameter data. In some implementations, the amount of data for transmitting the range model parameters is orders of magnitude less than the amount of data for transmitting the transmission parameter data.

In some instances, a heatmap cannot be modeled with the ranging model 600, such as when the heatmap is irregular. In these circumstances, heatmap data describing the irregular heatmap can be sent to the mobile device.

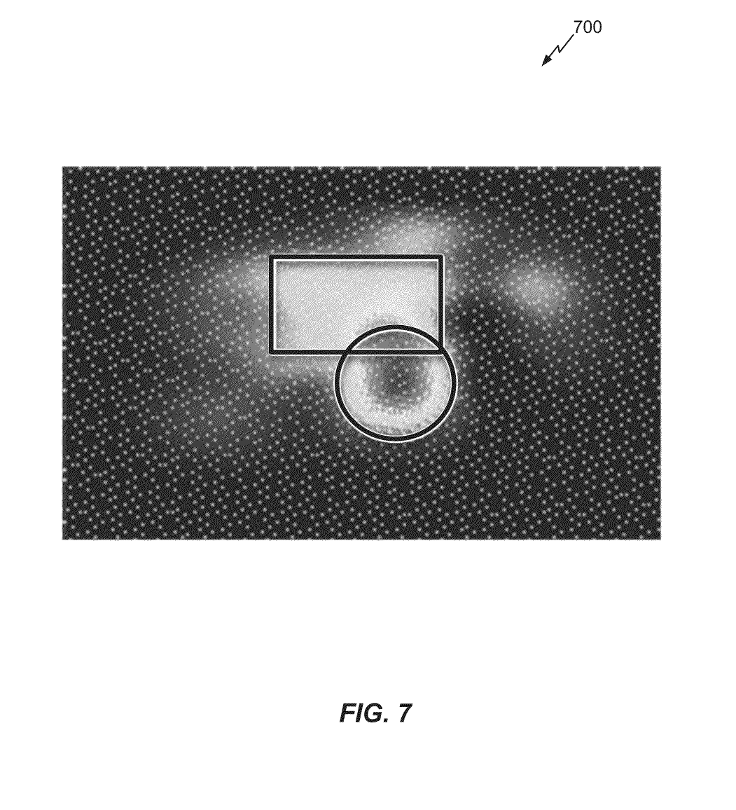

In an example, the heatmap may be irregular overall, but includes a ranging region, which may be represented using a ranging model (in this example, the heatmap has partially circular characteristics), as well as an irregular, non-ranging region, which cannot be represented using a ranging model and is preferably represented with data at multiple grid points. FIG. 7 depicts an irregular heatmap 700 that has a ranging region (identified by the white circle), as well as a clearly irregular, non-ranging region (identified by the white rectangle). The ranging region and the non-ranging region overlap. In a case such as that of FIG. 7, both ranging model data or parameters to enable a mobile device to compute a first heatmap for multiple points in the ranging region and a reduced-size heatmap data set describing the irregular heatmap for a plurality of points in the non-ranging region can be sent to the mobile device. By sending ranging model parameters for the ranging region of the heatmap, the amount of data sent to the mobile device is reduced relative to sending heatmap data for multiple points within the ranging region, while at the same time to improve accuracy of the mobile device's position fix in the non-ranging region, heatmap data is sent to augment the ranging model. Furthermore, in scenarios where the ranging region and the non-ranging region overlap, as illustrated in FIG. 7, the heatmap computed by the mobile device can include a summation of the heatmap data generated from the ranging model and the heatmap data received for the non-ranging region of the heatmap. In such a scenario, the heatmap data sent to augment the ranging model can include correction data to enable computation of the correct heatmap.

FIG. 8 depicts an exemplary method 800 for selecting positioning data to transmit from an access point to a mobile device. At least a portion of the method 800 can be performed by the apparatus described hereby, such as at least one of the user devices 106A-106L, the access points 104A-104G, the user device 200, and/or the access point 300.

In block 805, a heatmap is computed. The computed heatmap represents the access point's transmitted signal strength at a plurality of points distant from the access point's antenna.

In block 810, it is determined if the heatmap is a regular heatmap. The identification can be performed by an automatic algorithm, a human operator, or a combination of both. An automatic algorithm can determine that a heatmap is irregular by detecting a number of RSSI peaks, comparing the aggregated data to a plurality of standard shapes (e.g., a substantially circular shape, a substantially elliptical shape, and the like), and computing a distance of points having certain RSSI values to the center of the RSSI peaks and the variance from the standard shape. Irregular heatmaps can be identified by the server as being irregular, stored, and flagged as irregular when stored. Regular heatmaps can be identified by the server as being regular, stored, and flagged as regular when stored.

In block 815, if the heatmap is a regular heatmap, ranging model parameters are computed. The computed ranging model parameters are of the access point's transmitted signal strength from the access point's antenna. A ranging model can be used to reproduce (i.e., approximate) a nominal cone-shaped heatmap.

In block 820, at least one of the ranging model parameters and/or at least a portion of the heatmap are chosen as the positioning data to be transmitted. In an example, the ranging model parameters are chosen as the positioning data to be transmitted for a specific access point, if the heatmap is a regular heatmap. At least a part of the heatmap is chosen as the positioning data to be transmitted for the specific access point, if the heatmap is not a regular heatmap. The decision can be based on at least one of a required positioning accuracy of the mobile device, a network condition, the location of the mobile device, or the battery level of the mobile device. As an example of a decision based on a network condition, when a network has low bandwidth (e.g., due to network congestion), ranging model parameters are chosen to be sent instead of heatmaps, because sending ranging model parameters involves sending less data, and thus uses less bandwidth. In a further example, the ranging model parameters can be used with a positioning equation that uses parametric planes fitted with least-squares.

In block 825, the positioning data chosen in block 820 is transmitted from the access point to the mobile device. In an example, if the at least a portion of the heatmap is chosen as the positioning data, a flag indicating that the at least a portion of the heatmap is included in the positioning data can be transmitted to the mobile device. If the ranging model parameters are chosen as the positioning data, a flag indicating that the ranging model parameters are included in the positioning data can be transmitted to the mobile device. Further, in an example, if the at least a portion of the heatmap and the ranging model parameters are both included in the positioning data, a flag indicating that the at least a portion of the heatmap is included in the positioning data and a flag indicating that the ranging model parameters are included in the positioning data can be transmitted to the mobile device. Moreover, in an example, if the at least a portion of the heatmap and the ranging model parameters are both included in the positioning data, a flag indicating that the at least a portion of the heatmap is included in the positioning data and indicating that the ranging model parameters is included in the positioning data can be transmitted to the mobile device. The mobile device can then determine the mobile device's position using the received heatmap, the ranging model parameters (as input to a ranging model equation), or a combination of both the heatmap and the ranging model parameters.

The foregoing blocks are not limiting of the disclosed embodiments. The blocks can be combined and the order can be rearranged.

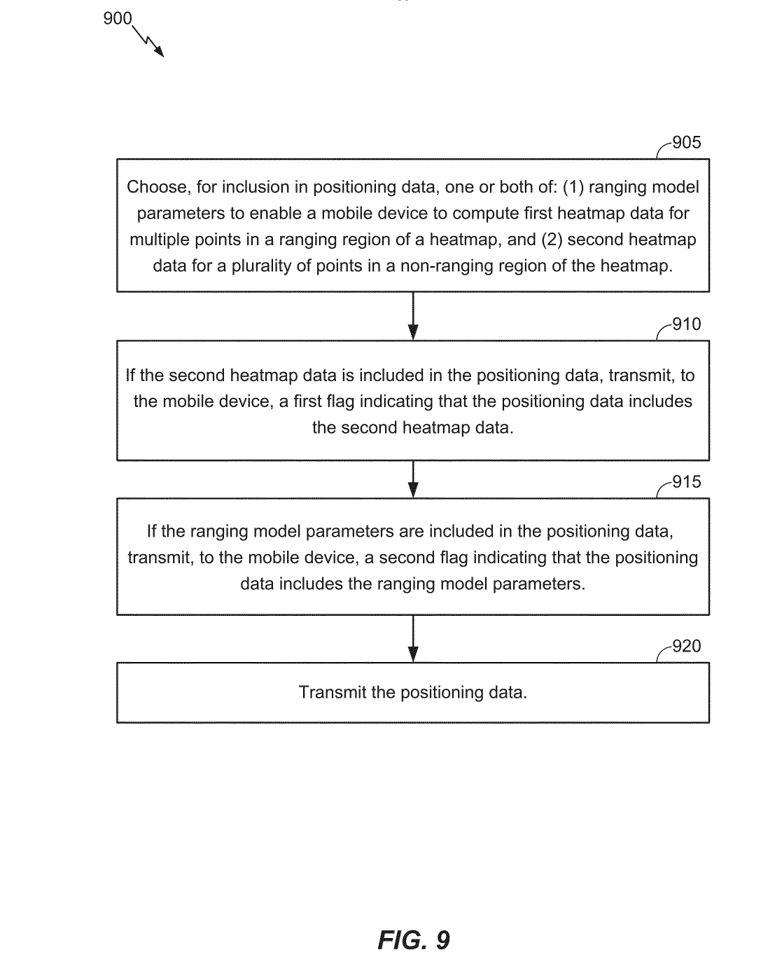

FIG. 9 depicts an exemplary method 900 for processing positioning data associated with one or more access points. At least a portion of the method 900 for processing positioning data associated with one or more access points can be performed by the apparatus described hereby, such as at least one of the access point 300 and/or the positioning server 390.

In block 905, one or both of: (1) ranging model parameters to enable a mobile device to compute first heatmap data for multiple points in a ranging region of a heatmap, and (2) second heatmap data for a plurality of points in a non-ranging region of the heatmap is chosen for inclusion in the positioning data. The second heatmap data can include received signal strength indication (RSSI) data, round-trip time (RTT) data, or both.

The ranging model parameters can be chosen for inclusion if the heatmap is a regular heatmap in the ranging region of the heatmap. Further, the second heatmap data can be chosen for inclusion if the heatmap is not a regular heatmap in the non-ranging region of the heatmap. Optionally, when the ranging region and the non-ranging region fully or partially overlap, ranging model parameters and the second heatmap data can be chosen for inclusion in the positioning data, where the heatmap data provides correction data to enable the mobile device to modify the computed heatmap data in the region of overlap. However, in other situations, the ranging region and non-ranging region may not geographically overlap, or may overlap relatively little, in which case, the ranging model parameters can be chosen for inclusion in the positioning data to enable the mobile device to compute the heatmap data for multiple grid points in the ranging region while heatmap data can also be chosen for inclusion in the positioning data to enable the mobile device to look up the heatmap data for a plurality of grid points in the non-ranging region.

Optionally, the choosing can be based on one of more of: (1) a required positioning accuracy of the mobile device; (2) the mobile device's location; and (3) the mobile device's battery level. The ranging model parameters can be chosen for inclusion in the positioning data if the mobile device's battery level is lower than a threshold amount. In some scenarios there may exist a tradeoff between accuracy and power consumption. Therefore, in some scenarios, it may be advantageous to use ranging model parameters for transmission even if the ranging model parameters are less accurate or if the heatmap represented by the ranging model parameters is not very regular, in order to reduce the amount of positioning data sent to the mobile device.

In block 910, a first flag is transmitted to the mobile device, if the second heatmap data is included in the positioning data. The first flag indicates the positioning data includes the second heatmap data for the plurality of points in the non-ranging region.

In block 915, a second flag is transmitted to the mobile device, if the ranging model parameters are included in the positioning data. The second flag indicates that the positioning data includes the ranging model parameters.

In block 920, the positioning data is transmitted.

The foregoing blocks are not limiting of the examples. The blocks can be combined and/or the order can be rearranged, as practicable.

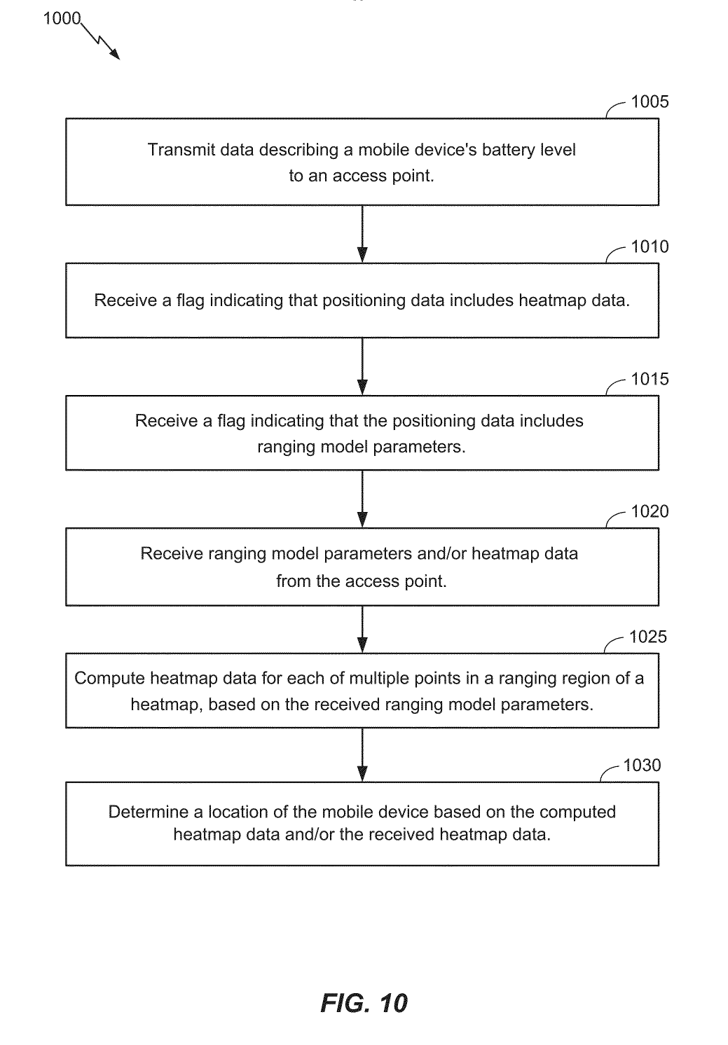

FIG. 10 depicts an exemplary method 1000 processing positioning data associated with one or more access points. At least a portion of the method 1000 for processing positioning data associated with one or more access points can be performed by the apparatus described hereby, such as at least one of the user devices 106A-106L, the user device 200, and/or the like.

In optional block 1005, data describing the mobile device's battery level is transmitted to an access point or another wireless transceiver in communication with a network. The data can be addressed to a server such as a positioning server.

In optional block 1010, a flag indicating that positioning data includes heatmap data is received. The heatmap data can include received signal strength indication (RSSI) data, round-trip time (RTT) data, or both.

In optional block 1015, a flag indicating that the positioning data includes ranging model parameters is received. In the optional blocks 1010 and 1015, the flags can originate from a server such as a positioning server.

In block 1020, ranging model parameters and/or heatmap data are received from the access point or another wireless transceiver in communication with a network. The received ranging model parameters and/or heatmap data can originate from a server, such as a positioning server. If the ranging region and the non-ranging region overlap, heatmap data for a plurality of points in a non-ranging region is received, where the heatmap data includes correction data to enable the mobile device to modify the computed heatmap data.

In optional block 1025, heatmap data is computed, at the user device, for each of multiple points in a ranging region of a heatmap, based on the received ranging model parameters. If correction data is received, the computed heatmap data is modified with the correction data. It is understood that if the positioning data includes heatmap data only, and does not include ranging model parameters, the method 1000 may not include optional block 1025.

In block 1030, a location of the mobile device is determined, based on the computed heatmap data and/or the received heatmap data. If the computed heatmap data was modified in block 1025, then the location of the mobile device is determined based on the modified computed heatmap data.

The foregoing blocks are not limiting of the examples. The blocks can be combined and/or the order can be rearranged, as practicable.

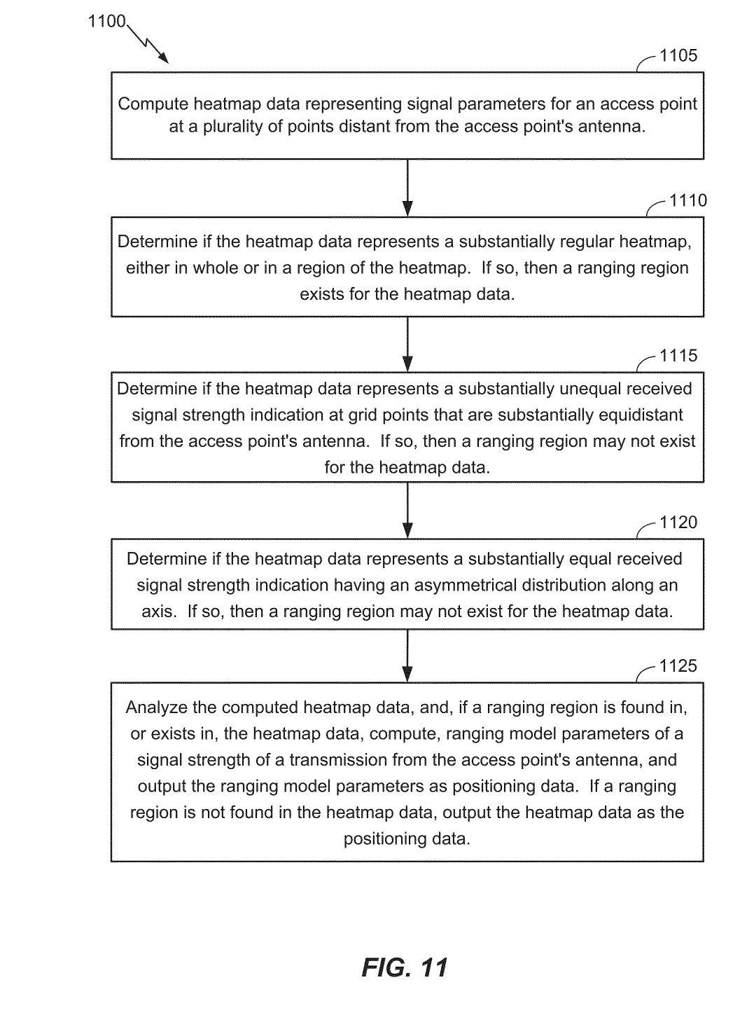

FIG. 11 depicts an exemplary method 1100 for processing positioning data associated with an access point having an antenna. At least a portion of the method 1100 for processing positioning data associated with an access point having an antenna can be performed by the apparatus described hereby, such as the positioning server 390.

In block 1105, heatmap data representing signal parameters for the access point is computed at a plurality of points distant from the access point's antenna. The received signal parameters can be received signal strength indication (RSSI), round-trip time (RTT), or both.

In block 1110, it is determined if the heatmap data represents a substantially regular heatmap, either in whole or in a region of the heatmap. If so, then a ranging region exists for the heatmap data. The heatmap data can represent substantially equal received signal parameters at grid points that are substantially equidistant from the access point's antenna or substantially equal received signal parameters having a symmetrical distribution along an axis. However, a regular heatmap can include other kinds of heatmaps, as discussed elsewhere herein.

In optional block 1115, it is determined if the heatmap data represents a substantially unequal received signal strength indication at grid points that are substantially equidistant from the access point's antenna. If so, then a ranging region may not exist for the heatmap data. In an example, if the heatmap data represents a substantially unequal received signal strength indication at grid points that are substantially equidistant from the access point's antenna, then a ranging region does not exist for the heatmap data.

In optional block 1120, it is determined if the heatmap data represents a substantially equal received signal strength indication having an asymmetrical distribution along an axis. If so, then a ranging region may not exist for the heatmap data. In an example, if the heatmap data represents a substantially equal received signal strength indication having an asymmetrical distribution along an axis, then a ranging region does not exist for the heatmap data.

In block 1125, the computed heatmap data is analyzed, and, if a ranging region is found in, or exists in, the heatmap data, ranging model parameters of a signal strength of a transmission from the access point's antenna are computed, and the ranging model parameters are output as the positioning data. If a ranging region is not found in the heatmap data, the heatmap data is output as the positioning data. The positioning data can then be transmitted to a mobile device, such as at least one of the user devices 106A-106L, the user device 200, and/or the like.

The foregoing blocks are not limiting of the examples. The blocks can be combined and/or the order can be rearranged, as practicable.

Further, the illustrative logical blocks, modules, circuits, and algorithm blocks described in connection with the embodiments disclosed herein may be implemented as electronic hardware, computer software, or combinations of both. To clearly illustrate this interchangeability of hardware and software, illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

In some aspects, the teachings herein can be employed in a multiple-access system capable of supporting communication with multiple users by sharing the available system resources (e.g., by specifying one or more of bandwidth, transmit power, coding, interleaving, and so on). For example, the teachings herein can be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein can be designed to implement one or more standards, such as IS-95, cdma2000, IS-856, W-CDMA, TDSCDMA, and other standards. A CDMA network can implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein can be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure can be described using 3GPP terminology, it is to be understood that the teachings herein can be applied to 3GPP (e.g., Re199, Re15, Re16, Re17) technology, as well as 3GPP2 (e.g., 1×RTT, 1×EV-DO RelO, RevA, RevB) technology and other technologies. The techniques can be used in emerging and future networks and interfaces, including Long Term Evolution (LTE).

At least a portion of the methods, sequences, and/or algorithms described in connection with the embodiments disclosed herein can be embodied directly in hardware, in software executed by a processor, or in a combination of the two. In an example, a processor includes multiple discrete hardware components. A software module may reside in random-access memory (RAM), flash memory, read-only memory (ROM), erasable programmable read-only memory (EPROM), electrically erasable programmable read-only memory (EEPROM), registers, hard disk, a removable disk, a compact disc read-only memory (CD-ROM), and/or any other form of storage medium known in the art. An exemplary storage medium (e.g., a memory) can be coupled to the processor such that the processor can read information from, and write information to, the storage medium. In an alternative, the storage medium may be integral with the processor.

Further, many embodiments are described in terms of sequences of actions to be performed by, for example, elements of a computing device. The actions described herein can be performed by a specific circuit (e.g., an application-specific integrated circuit (ASIC)), by program instructions being executed by one or more processors, or by a combination of both. Additionally, a sequence of actions described herein can be considered to be embodied entirely within any form of computer readable storage medium having stored therein a corresponding set of computer instructions that upon execution would cause an associated processor (such as a special-purpose processor) to perform at least a portion of a function described herein. Thus, the aspects of the invention may be embodied in a number of different forms, all of which have been contemplated to be within the scope of the claimed subject matter. In addition, for each of the embodiments described herein, a corresponding circuit of any such embodiments may be described herein as, for example, “logic configured to” perform a described action.

The disclosed devices and methods can be designed and can be configured into a computer-executable file that is in a Graphic Database System Two (GDSII) compatible format, an Open Artwork System Interchange Standard (OASIS) compatible format, and/or a GERBER (e.g., RS-274D, RS-274X, etc.) compatible format, which are stored on a non-transitory (i.e., a non-transient) computer-readable media. The file can be provided to a fabrication handler who fabricates with a lithographic device, based on the file, an integrated device. Deposition of a material to form at least a portion of a structure described herein can be performed using deposition techniques such as physical vapor deposition (PVD, e.g., sputtering), plasma-enhanced chemical vapor deposition (PECVD), thermal chemical vapor deposition (thermal CVD), and/or spin-coating. Etching of a material to form at least a portion of a structure described herein can be performed using etching techniques such as plasma etching. In an example, the integrated device is on a semiconductor wafer. The semiconductor wafer can be cut into a semiconductor die and packaged into a semiconductor chip. The semiconductor chip can be employed in a device described herein (e.g., a mobile device).

At least one embodiment can include a non-transitory (i.e., a non-transient) machine-readable media and/or a non-transitory (i.e., a non-transient) computer-readable media embodying instructions which, when executed by a processor (such as a special-purpose processor), transform the processor and any other cooperating devices into a machine (e.g., a special-purpose processor) configured to perform at least a part of a function described hereby and/or transform a processor and any other cooperating devices into at least a part of the apparatus described hereby. Further, at least one embodiment of the invention can include a computer readable media embodying at least a part of a method described herein. Accordingly, the invention is not limited to illustrated examples and any means for performing the functions described herein are included in at least one embodiment of the invention.

Nothing stated or illustrated depicted in this application is intended to dedicate any component, step, block, feature, object, benefit, advantage, or equivalent to the public, regardless of whether the component, step, block, feature, object, benefit, advantage, or the equivalent is recited in the claims.

While this disclosure describes exemplary embodiments of the invention, changes and modifications can be made to the information disclosed herein without departing from the scope of the invention as defined by the appended claims.

What is claimed is:

1. A method for processing positioning data associated with one or more access points, comprising:
choosing, for inclusion in the positioning data, one or both of:
ranging model parameters to enable a mobile device to compute first heatmap data for multiple points in a ranging region of a heatmap, and
second heatmap data for a plurality of points in a non-ranging region of the heatmap; and
transmitting the positioning data.

2. The method of claim 1, wherein the choosing includes:
choosing the ranging model parameters for inclusion, if the heatmap is a regular heatmap in the ranging region of the heatmap; and
choosing the second heatmap data for inclusion, if the heatmap is not a regular heatmap in the non-ranging region of the heatmap.

3. The method of claim 1, wherein the choosing is based on one of more of:
a required positioning accuracy of the mobile device;
a location of the mobile device; and
a battery level of the mobile device.

4. The method of claim 3, wherein the choosing comprises choosing the ranging model parameters if the mobile device's battery level is lower than a threshold amount.

5. The method of claim 1, further comprising:
transmitting to the mobile device, if the second heatmap data is included in the positioning data, a first flag indicating that the positioning data includes the second heatmap data for the plurality of points in the non-ranging region; and
transmitting to the mobile device, if the ranging model parameters are included in the positioning data, a second flag indicating that the ranging model parameters are chosen as the positioning data.

6. The method of claim 1, wherein the second heatmap data comprises received signal strength indication data, round-trip time data, or both.

7. The method of claim 1, wherein the positioning data includes both the ranging model parameters and the second heatmap data, the ranging region and the non-ranging region fully or partially overlap, and the second heatmap data provides correction data to enable the mobile device to modify the computed first heatmap data in a region of overlap.

8. A server for processing positioning data associated with one or more access points, comprising:
a processor; and
a memory coupled to the processor and configured to cause the processor to:
choose, for inclusion in the positioning data, one or both of:
ranging model parameters to enable a mobile device to compute first heatmap data for multiple points in a ranging region of a heatmap, and
second heatmap data for a plurality of points in a non-ranging region of the heatmap; and
transmit the positioning data.

9. The server of claim 8, wherein the memory is further configured to cause the processor to:
choose the ranging model parameters for inclusion, if the heatmap is a regular heatmap in the ranging region of the heatmap; and
choose the second heatmap data for inclusion, if the heatmap is not a regular heatmap in the non-ranging region of the heatmap.

10. The server of claim 8, wherein the choosing is based on one of more of:
a required positioning accuracy of the mobile device;
a location of the mobile device; and
a battery level of the mobile device.

11. The server of claim 10, wherein the choosing comprises choosing the ranging model parameters if the mobile device's battery level is lower than a threshold amount.

12. The server of claim 8, wherein the memory is further configured to cause the processor to:
transmit to the mobile device, if the second heatmap data is included in the positioning data, a first flag indicating that the positioning data includes the second heatmap data for the plurality of points in the non-ranging region; and
transmit to the mobile device, if the ranging model parameters are included in the positioning data, a second flag indicating that the ranging model parameters are chosen as the positioning data.

13. The server of claim 8, wherein the second heatmap data comprises received signal strength indication data, round-trip time data, or both.

14. The server of claim 8, wherein the positioning data includes both the ranging model parameters and the second heatmap data, the ranging region and the non-ranging region fully or partially overlap, and the second heatmap data provides correction data to enable the mobile device to modify the computed first heatmap data in a region of overlap.

15. A non-transitory computer-readable medium, comprising processor-executable instructions stored thereon to be retrieved and executed by one or more processors, the processor-executable instructions including instructions to:
choose, for inclusion in positioning data, one or both of:
ranging model parameters to enable a mobile device to compute first heatmap data for multiple points in a ranging region of a heatmap, and
second heatmap data for a plurality of points in a non-ranging region of the heatmap; and
transmit the positioning data.

16. The non-transitory computer-readable medium of claim 15, wherein the processor-executable instructions further include instructions to:
choose the ranging model parameters for inclusion, if the heatmap is a regular heatmap in the ranging region of the heatmap; and
choose the second heatmap data for inclusion, if the heatmap is not a regular heatmap in the non-ranging region of the heatmap.

17. The non-transitory computer-readable medium of claim 15, wherein the choosing is based on one of more of:
a required positioning accuracy of the mobile device;
a location of the mobile device; and
a battery level of the mobile device.

18. The non-transitory computer-readable medium of claim 17, wherein the choosing comprises choosing the ranging model parameters if the mobile device's battery level is lower than a threshold amount.

19. The non-transitory computer-readable medium of claim 15, wherein the processor-executable instructions further include instructions to:
transmit to the mobile device, if the second heatmap data is included in the positioning data, a first flag indicating that the positioning data includes the second heatmap data for the plurality of points in the non-ranging region; and
transmit to the mobile device, if the ranging model parameters are included in the positioning data, a second flag indicating that the ranging model parameters are chosen as the positioning data.

20. The non-transitory computer-readable medium of claim 15, wherein the second heatmap data comprises received signal strength indication data, round-trip time data, or both.

21. The non-transitory computer-readable medium of claim 15, wherein the positioning data includes both the ranging model parameters and the second heatmap data, the ranging region and the non-ranging region fully or partially overlap, and the second heatmap data provides correction data to enable the mobile device to modify the computed first heatmap data in a region of overlap.

22. A server configured to process positioning data associated with one or more access points, comprising:
means for choosing, for inclusion in the positioning data, one or both of:
ranging model parameters to enable a mobile device to compute first heatmap data for multiple points in a ranging region of a heatmap, and
second heatmap data for a plurality of points in a non-ranging region of the heatmap; and
means for transmitting the positioning data.

23. The server of claim 22, wherein the means for choosing includes:
means for choosing the ranging model parameters for inclusion, if the heatmap is a regular heatmap in the ranging region of the heatmap; and
means for choosing the second heatmap data for inclusion, if the heatmap is not a regular heatmap in the non-ranging region of the heatmap.

24. The server of claim 22, wherein the choosing is based on one of more of:
a required positioning accuracy of the mobile device;
a location of the mobile device; and
a battery level of the mobile device.

25. The server of claim 24, wherein the means for choosing comprises means for choosing the ranging model parameters if the mobile device's battery level is lower than a threshold amount.

26. The server of claim 22, further comprising:
means for transmitting to the mobile device, if the second heatmap data is included in the positioning data, a first flag indicating that the positioning data includes the second heatmap data for the plurality of points in the non-ranging region; and
means for transmitting to the mobile device, if the ranging model parameters are included in the positioning data, a second flag indicating that the ranging model parameters are chosen as the positioning data.

27. The server of claim 22, wherein the second heatmap data comprises received signal strength indication data, round-trip time data, or both.

28. The server of claim 22, wherein the positioning data includes both the ranging model parameters and the second heatmap data, the ranging region and the non-ranging region fully or partially overlap, and the second heatmap data provides correction data to enable the mobile device to modify the computed first heatmap data in a region of overlap.
